(19) United States
(12) Patent Application Publication
(10) Pub. No.: US 2003/0120820 A1
(43) Pub. Date: Jun. 26, 2003

(54) Set -up method and apparatus for auto-negotiation

(76) Inventor: Yi-Ping Chen, MiaoLi (TW)

Correspondence Address: Raymond Sun, 12420 Woodhall Way, Tustin, CA, 92782, US

(21) Appl. No.: 10/256,344

(22) Filed: Sep. 27, 2002

(30) Foreign Application Priority Data
Dec. 21, 2001 (TW) 90131775

(51) Int. Cl. G06F 15/16; G06F 9/00

(52) U.S. Cl. 709/250; 713/1

(57) ABSTRACT

The present invention provides a set-up method and apparatus for auto-negotiation that is used in a computer system with a network interface device to reduce the boot up time for the computer system and the complexity of boot up program. In the present invention, some of the operations of initializing the network interface card are performed while the computer system boots up to reduce the entire boot up time of the computer system. Moreover, in present invention, some of the operations in initializing the network interface card are performed by the hardware on the network interface card, which also reduces the complexity of the boot up operation of a computer system.

### BACKGROUND OF THE INVENTION

(a). Field of the Invention

The present invention relates to a set up method and apparatus for auto-negotiation. Especially, the present invention relates to a set-up method and apparatus for auto-negotiation which is used in a network system and is used for a computer system having a network interface device to reduce the boot up time of a computer.

(b). Description of the Prior Arts

Network interface card is a peripheral device that links a computer and a network system. The most common network interface cards seen in the market usually are 100Base-Tx, 100Base-Fx and Gigabit Ethernet. Most of time, the PHY layer of the network interface card will detect the capability of data transfer of other nodes, link partner or a remote computer. This is so called auto-negotiation, and its related configurations have been defined in IEEE 802.3u standard.

The configuration information of the data transfer of a network interface card includes the speed of the data transfer (such as 10 Mbps or 100 Mbps) and the working mode, wherein the working mode can be single or duplex. The duplex mode further includes the half duplex mode and the full duplex mode. In the duplex mode, a computer can transfer and receive data simultaneously, while in the single mode, a computer only transfer or receive data. The full duplex means a computer can transfer and receive data at the same time in the network system while the half duplex means the computer only transfers or receives data at a certain time.

The mechanism of auto-negotiation allows the computers (or devices) that linked each other in the network to automatically detect the PHY layer of each other and further to detect the speed of data transfer and working mode of each other as well. Then, the mechanism of auto-negotiation can determine the optimal speed of data transfer and working mode that all of computers will follow. In the data link layer of the network interface card, the media access control (MAC) will use the media independent interface (MII) to set up the value of auto-negotiation advertisement register (ANAR) in the PHY layer. The ANAR is used to hold the information of local computer that need to be posted for the remote computer when they communicate through the auto-negotiation mechanism.

Please refer to FIG. 1, which is a diagram of auto-negotiation applied on Fast Ethernet network system according to the prior art. As shown in FIG. 1, the Open System Interconnection Reference Mode (OSI) has been illustrated, and which is the most common protocol used in network communication. The OSI basically is consistent of Physical Layer 1, Data Link Layer 2 and others, which are mapping respectively to each layer of Carrier Sense Multiple Access/Collision Detection (CSMA/CD) of 802.3 standard in IEEE. The auto-negotiation mode is used in the Physical Layer 1 of OSI. The PHY layer is mapping to the PHY 10 of CSMA/CD and the PHY 10 is between the Media Independent Interface 11 and Media Dependent Interface 12. The Media Dependent Interface 12 is linked to other network device thru a physical line such as a UTP cable or a fiber optical cable. The Data Link Layer 2 is consistent of a Logic Link Control (LLC) 20 layer and a Media Access Control (MAC) 21 layer. And most of time, a LAN driver is referred to the driver used in Media Access Control (MAC) 21 layer.

The Physical layer PHY 10 is consistent of Physical Coding Sublayer (PCS) 101, Physical Medium Attachment (PMA) 102, Physical Medium Dependent (PMD) 103 and Auto Negotiation layer 104; the Auto Negotiation layer is the core of operation in the auto-negotiation mode.

In general, when the driver being loaded into the network interface card, the value of auto-negotiation advertisement register (ANAR) in the PHY layer 10 will be set up according to a configuration file of the system or by parameters. The system will process the related parameters first and then start the auto-negotiation process to detect the Auto

Negotiation layer 104. The disadvantage of aforesaid process is that the value of auto-negotiation advertisement register (ANAR) in the PHY layer 10 is needed to be set up by the driver and the process of auto-negotiation is also driven by the driver. What happened is loading driver and initiation of values in the PHY 10 will take a long period of time. Since the period of the time is included in the system boot up time, the system needs to wait such a long time to start up other operations or processes.

As described above, because the driver loading and the initiation of the network interface card, the system will take a long time to complete the entire boot up operation. Unfortunately, long time waiting is not welcome for most of users. Moreover, when the system tests the network interface card, some of test programs examine if the initialization period is within a limited period, such as HCT 9.502 LAN Self-Test in Win2000 or HCT 10.x LAN Self-Test in Windows XT. So, if the boot up time takes too long and exceed the limited period, system boot up failure will occur and impact the overall performance of system boot up.

Please refer to FIG. 2, which is a diagram of boot up procedure of a computer system. As shown in FIG. 2, if the entire boot up time of the computer system is k seconds, and the time of initiation of the driver loaded into the network interface card is n seconds, wherein setting up the value of auto-negotiation advertisement register (ANAR) in the PHY layer and starting up the auto-negotiation process will take m seconds. As described, such a long time of m seconds will be caused in setting up the value of auto-negotiation advertisement register (ANAR) in the PHY layer and starting up the auto-negotiation process, so, the entire boot up time of the system will be reduced if the time of m seconds can be saved by transfer it to other boot up procedure.

### SUMMARY OF THE INVENTION

An aspect of the present invention reduces the boot up time of a computer system and the complexity of boot up program. In the present invention, the initialization and related process of a network interface card will be designed to be processed right after the computer system starting up but before the network interface card driver being processed to reduce the entire boot up time of a computer system. Moreover, some of the operations in initializing the network interface card are performed by the hardware on the network interface card, which also reduces the complexity of the operation of a computer system boot up.

The method of the present invention comprises:

(a) start the computer system;

(b) load the set up value for the auto-negotiation from EEPROM to the auto-negotiation advertisement register (ANAR) of the MAC;

(c) determine whether set up the register of the PHY and restart auto-negotiation based on the set up value in the auto-negotiation advertisement register (ANAR) of the MAC;

(d) load the operation system into the computer system;

(e) load the driver of the network interface device; and

(f) the driver sets up the parameters in the MAC based on the result of auto-negotiation.

The parameter in the step (b) can be stored in the EEPROM in advance. The MAC of the network interface device reads the information of the set up in the auto-negotiation and loads the information into the auto-negotiation advertisement register (ANAR) of the PHY. Specifically, the PHY of the network interface device complies with the PHY standard of the IEEE 802.3.

In step (c), restarting auto-negotiation means the PHY of the network interface device will determine whether to respond or not based on the set up value in the auto-negotiation advertisement register (ANAR) of the MAC.

In step (e), loading the driver of the network interface device initializes of the set up of the Media Access Control (MAC).

Thru the method of the present invention, the boot up time of the computer system will extremely reduced and it is not necessary to complicate hardware design on the network interface device, and furthermore, it improves the overall performance of the network system eventually.

The appended drawings will provide further illustration of the present invention, together with the description, serve to explain the principles of the invention.

### BRIEF DESCRIPTION OF THE DRAWINGS

FIG. 1 shows an embodiment of the auto-negotiation mode applied in the communication protocol of the Ethernet network system.

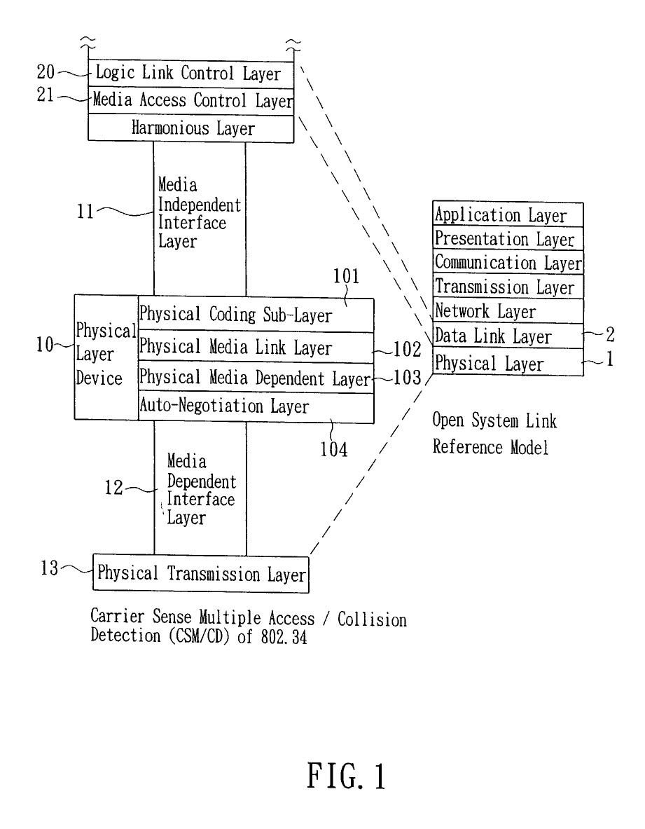

FIG. 2 shows the boot up procedure of a computer system in prior art.

FIG. 3 shows the boot up procedure of a computer system according to an embodiment of the present invention.

FIG. 4 shows the circuit of the hardware according to one embodiment of the present invention.

FIG. 5 shows an embodiment of an operation flow of the present invention.

### DETAILED DESCRIPTION OF THE PRESENT INVENTION

The present invention relates to a set-up method and apparatus for auto-negotiation. Especially, the present invention relates to a set-up method and apparatus for auto-negotiation which is used in a network system and is used for a computer system having a network interface device to reduce the boot up time and complexity of the computer program. The present invention initializes a network interface card and performs the related operations right after the computer system starting up but before the network interface card driver being processed, to reduce the entire boot up time of a computer system. Moreover, some of the operations in initiation of a network interface card will be handled by the hardware on the network interface card, which also reduces the complexity of the computer program.

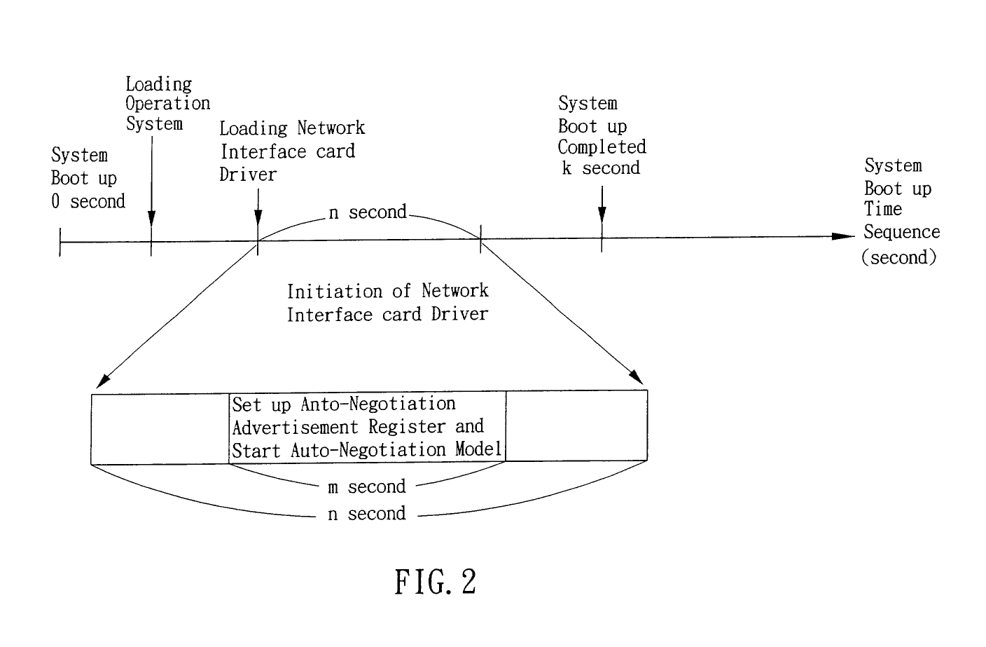

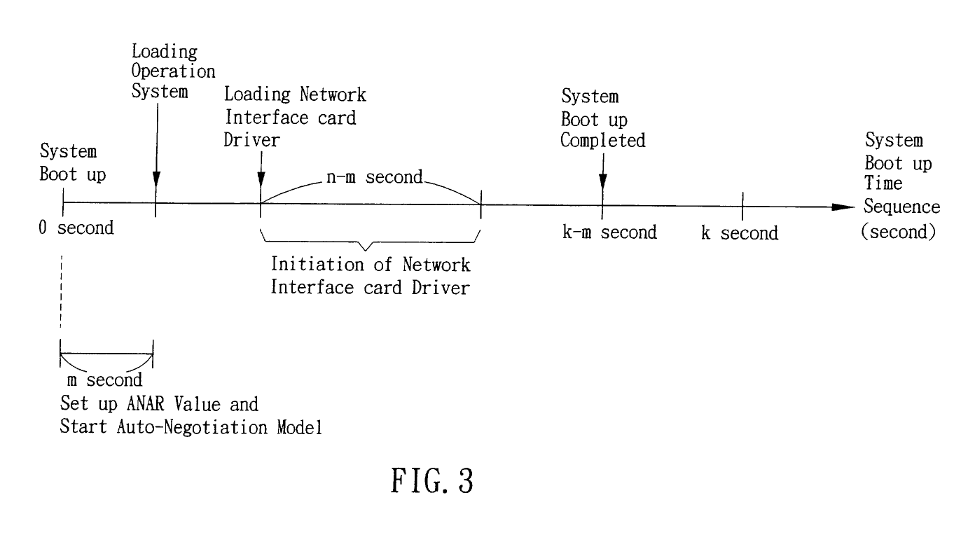

Please refer to FIG. 3. FIG. 3 shows an embodiment of the boot up procedure of a computer system according to the present invention. Comparing with the FIG. 2 of prior art, the present invention sets up the parameter value of the auto-negotiation advertisement register (ANAR) of the PHY and performs auto-negotiation by hardware. More details, the present invention initializes the auto-negotiation advertisement register (ANAR) and performs auto-negotiation mode by hardware configuration when the system starts up. If the total time of initializing the auto-negotiation advertisement register (ANAR) and performing the auto-negotiation is m seconds, obviously, the time used in driver initiation will be reduced from n seconds to n-m seconds. It means, the entire boot up time of the computer system saves m seconds and the entire process of boot up completes within k-m seconds. Thus, the present invention reduces the boot up time of a computer system.

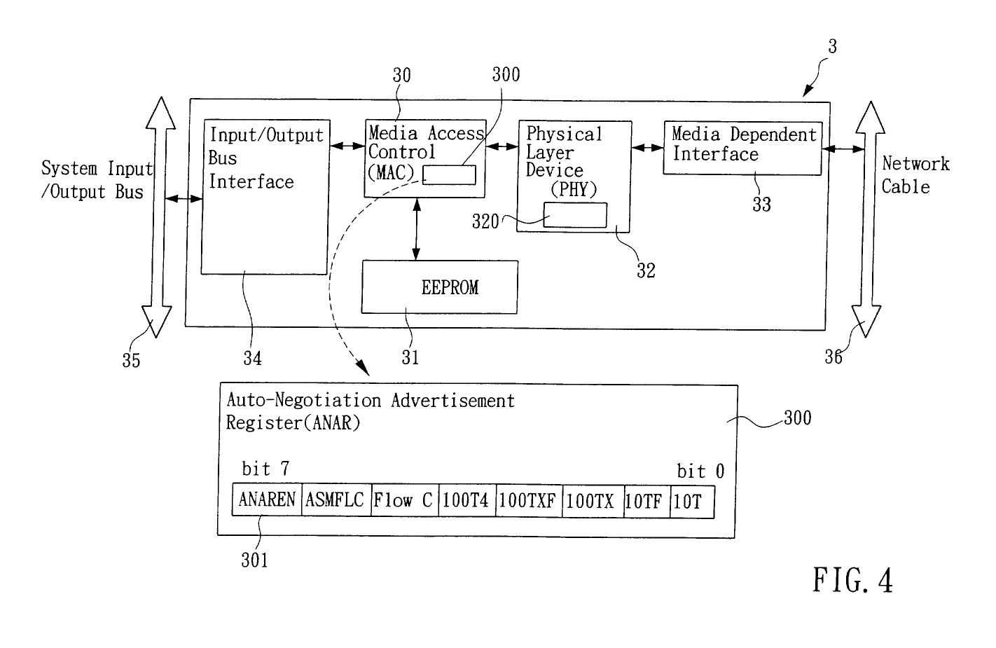

Please refer to FIG. 4. FIG. 4 shows the circuit of the hardware according to one embodiment of the present invention. The present invention initializes auto-negotiation while the computer system boots up to reduce the boot up time, a circuit of hardware is therefore designed to fulfill the purpose. As shown in FIG. 4, a network interface card 3 comprises the Media Access Control (MAC) 30, an EEPROM 31, a Physical (PHY) layer 32, a Media Dependent Interface (MDI) 33 and an Input/Output Bus Interface 34. The network interface card 3 is typically a Peripheral Component Interconnect (PCI) interface card. The EEPROM 31 could be a Mask ROM, a Flash ROM or a Non-Volatile memory.

The Media Dependent Interface (MDI) 33 is linked to the Input/Output Bus interface 35 of a computer system thru the Input/Output Bus Interface 34, the Media Access Control (MAC) 30 includes an Auto-Negotiation Advertisement Register (ANAR) 300 and the EEPROM 31 is used to store the information of setting up the Auto-Negotiation Advertisement Register (ANAR) 300 and the information of the Auto-Negotiation. According to the present invention, some information that set up the Auto-Negotiation Advertisement Register (ANAR) 300 will be stored in the EEPROM 31. When the computer system starts up and the Media Access Control (MAC) 30 receives the message from the computer system (such as PCI reset message), the set up information stored in the EEPROM 31 will be loaded into the MAC. Then, in response to the enabling settings for the Auto-Negotiation Advertisement Register (ANAR) 300, selectively set up the PHY 32 based on the Auto-Negotiation Advertisement Register (ANAR) 300. The PHY 32 comprises a register 320 to receive the set up information, wherein preferred length of data in the Auto-Negotiation Advertisement Register (ANAR) 300 is 8 bits. For example, the eighth bit (bit 7) “ANAREN” 301 in the Auto-Negotiation Advertisement Register (ANAR) 300 determines whether load the set up information of the Auto-Negotiation Advertisement Register (ANAR) 300 into PHY 32 and start the re-autonegotiation or not.

After the set up information is loaded into register 320 of the PHY 32, the network interface card will perform auto-negotiation by linking a network system thru the Media Access Control (MAC) 30 to detect the auto-negotiation mode of other computer system in the network thru the network cable 36 (such as a UTP cable or a fiber optical cable).

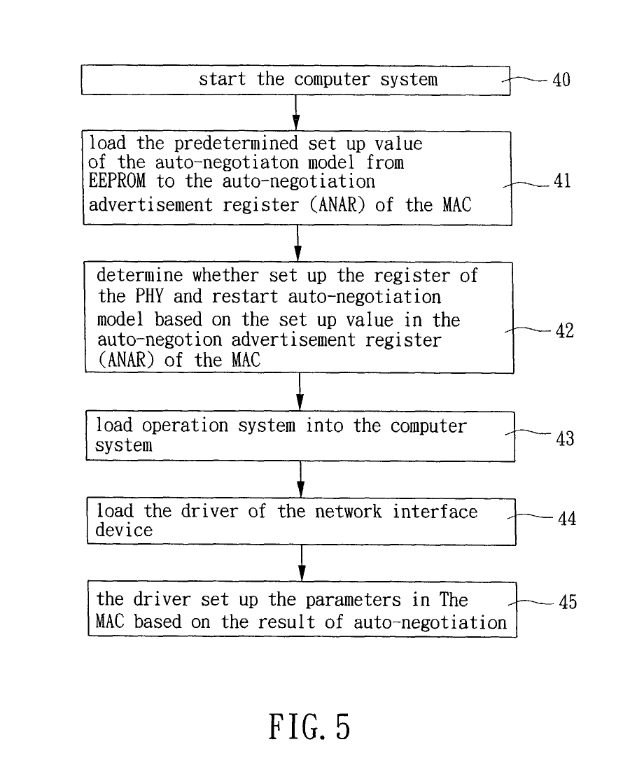

Please refer to FIG. 5. FIG. 5 shows a flow chart according to an embodiment of the present invention. A computer system with a network interface device links another network system. The present invention loads the parameters of the auto-negotiation into the Auto-Negotiation Advertisement Register (ANAR) of the MAC of the network interface card right after the computer system boot up. Then, the computer system performs auto-negotiation with other devices in the network system. Preferably, the set up information of the auto-negotiation is stored in a Non-Volatile memory chip, such as an EEPROM.

The present invention comprises the steps:

(a) start the computer system (step 40);

(b) load the predetermined settings for auto-negotiation from EEPROM to the auto-negotiation advertisement register (ANAR) of the MAC (step 41);

(c) determine whether set up the register of the PHY and restart auto-negotiation based on the setting in the auto-negotiation advertisement register (ANAR) of the MAC (step 42);

(d) load the operation system into the computer system (step 43);

(e) load the driver of the network interface device (step 44); and

(f) the driver set up the parameters in the MAC based on the result of auto-negotiation (step 45).

In another embodiment, the register of the PHY has default setting when the chip comes out from the manufacture. When the computer system powers up, the setting auto-negotiation will be invoked based on the default.

In step (b), the set up parameter of the auto-negotiation can be stored in the EEPROM of the network interface device in advance based on the preferences of the manufacture, or by a user depending on his need.

In step (b), load the predetermined set up value of the auto-negotiation mode from EEPROM to the auto-negotiation advertisement register (ANAR) of the MAC, when the computer system starts up. The predetermined set up value of the auto-negotiation mode in the EEPROM will be loaded into the auto-negotiation advertisement register (ANAR) of the MAC based on a system signal; such as a PCI reset signal.

In step (c), determine whether set up the value in the register of the PHY and whether restart the auto-negotiation (Re-Autonegotiation) based on the set up value in the auto-negotiation advertisement register (ANAR) of the MAC. The PHY layer of the network interface device operates in response to the setting in the auto-negotiation advertisement register (ANAR).

Also in step (c), the network interface device will read the setting for auto-negotiation and load the setting into the auto-negotiation advertisement register (ANAR) of the PHY of the network interface device. The auto-negotiation advertisement register (ANAR) stores the information for the local computer system that need to be advertised to other remote computer system in the network so that the remote computer can acquire the information of the local computer system during the auto-negotiation. Specifically, the PHY of the network interface device complies with the PHY standard of the IEEE 802.3.

In step (d), the operation system will be loaded into the computer system after the network interface device starts the auto-negotiation.

In step (e), load the driver 44 of the network interface device to initialize the Media Access Control (MAC).

According to the present invention, the boot up time of the computer system will be significantly reduced and some of the operations of the network driver initialization are performed by the hardware on the network interface card. Furthermore, it is not necessary to complicate hardware design on the network interface device, but improve the overall performance of the network system eventually.

While the present invention has been shown and described with reference to a preferred embodiment thereof, and in terms of the illustrative drawings, it should be not considered as limited thereby. Various possible modification could be conceived of by one skilled in the art without departing from the scope and the sprit of the present invention.

What is claimed is:

1. A set up method for auto-negotiation for a computer system with a network interface device, said method comprising the following steps:
a. starting said computer system;
b. loading a predetermined set up value for auto-negotiation into an auto-negotiation advertisement register (ANAR) of a MAC of said network interface device;
c. said network interface device determining whether restart auto-negotiation mode based on the set up value for auto-negotiation.

2. The set up method for auto-negotiation of claim 1, wherein said set up value for auto-negotiation is stored in advance in a non-volatile memory of said network interface device.

3. The set up method for auto-negotiation of claim 2, wherein said non-volatile memory is an EEPROM.

4. The set up method for auto-negotiation of claim 2, wherein said network interface device complies with the PHY standard of IEEE 802.3.

5. The set up method for auto-negotiation of claim 1, wherein said network interface device is a Peripheral Component Interconnect (PCI) network card.

6. The set up method for auto-negotiation of claim 1, further comprising a step of loading an operation system into said computer system.

7. The set up method for auto-negotiation of claim 1, wherein, said auto-negotiation advertisement register (ANAR) comprises an enable set up for determining of whether restart said auto-negotiation mode.

8. The set up method for auto-negotiation of claim 1, wherein, said auto-negotiation advertisement register (ANAR) is 8bits.

9. The set up method for auto-negotiation of claim 6, further comprising a step of loading a driver of said network interface device into said computer system.

10. A set up method for auto-negotiation for a computer system with a network interface device, comprising the following steps:
a. starting said computer system;
b. loading a predetermined set up value for auto-negotiation into an auto-negotiation advertisement register (ANAR) of a MAC of said network interface device;
c. said network interface device determining whether restart auto-negotiation based on the set up value for auto-negotiation.
d. loading an operation system into said computer system; and
e. loading a driver associated with said network interface device.

11. The set up method for auto-negotiation of claim 10, wherein said set up value for auto-negotiation is stored in advance in a non-volatile memory of said network interface device.

12. The set up method for auto-negotiation of claim 11, wherein said non-volatile memory is an EEPROM.

13. The set up method for auto-negotiation of claim 10, wherein said network interface device complies with the PHY standard of IEEE 802.3.

14. The set up method for auto-negotiation of claim 10, wherein said network interface device is a Peripheral Component Interconnect (PCI) network card.

15. The set up method for auto-negotiation of claim 10, further comprising setting up said MAC based on the result resulting from said driver restarting said auto-negotiation.

16. The set up method for auto-negotiation of claim 10, wherein said auto-negotiation advertisement register (ANAR) comprises an enable set up for determining whether restart said auto-negotiation mode.

17. An auto-negotiation network interface device for used in a personal computer comprising:
a media access control (MAC), having a first auto-negotiation advertisement register (ANAR); and
a PHY device, having a second auto-negotiation advertisement register (ANAR);
wherein said MAC loads a default set up value from a non-volatile memory into said first auto-negotiation advertisement register (ANAR) in response to an initiation signal from said personal computer and said MAC to determine whether set up said second auto-negotiation advertisement register (ANAR) and restart auto-negotiation according to said default set up value.

18. The network interface device of claim 17, wherein said auto-negotiation advertisement register (ANAR) comprises an auto-negotiation advertisement register enable bit (ANAREN).

19. The network interface device of claim 17, wherein said non-volatile memory is an EEPROM.

20. The network interface device of claim 17, wherein said initiation message is a PCI reset message.
